(19) United States
(12) Patent Application Publication
(10) Pub. No.: US 2025/0309638 A1
(43) Pub. Date: Oct. 2, 2025

(54) PROCESSING SYSTEMS AND METHODS WITH ADJUSTABLE VOLTAGE LIMITS

(71) Applicant: Intel Corporation, Santa Clara, CA (US)

(72) Inventors: Somvir Singh DAHIYA, Hillsboro, OR (US); Daniel J. RAGLAND, Sherwood, OR (US); Scot KELLAR, Bend, OR (US); Lei JIANG, Camas, WA (US); Clint WHITESIDE, Hillsboro, OR (US)

(21) Appl. No.: 18/622,375

(22) Filed: Mar. 29, 2024

(51) Int. Cl. H02H 9/04; G06F 1/26; H02M 3/155

(52) U.S. Cl. CPC H02H 9/04; G06F 1/26; H02M 3/155

(57) ABSTRACT

In some embodiments, a processor system with a programmable voltage/frequency voltage limit or voltage limits is provided.

### TECHNICAL FIELD

Embodiments of the invention relate to the field of integrated circuit devices; and more specifically, to the field of power and performance management.

### BRIEF DESCRIPTION OF THE DRAWINGS

The disclosure may best be understood by referring to the following description and accompanying drawings that are used to illustrate embodiments of the invention. In the drawings:

FIG. 1 is a block diagram of a processor system 100 in accordance with some embodiments.

FIG. 2 is a diagram illustrating a framework for providing configurable processor maximum voltage limits in accordance with some embodiments.

FIG. 3 is a block diagram showing a processor system having configurable maximum voltage limits in accordance with some embodiments.

FIG. 4 is a flow diagram of a routine 400 to identify a maximum voltage limit in accordance with some embodiments.

FIG. 5 illustrates an example computing system in accordance with some embodiments.

FIG. 6 illustrates a block diagram of an example processor 600 that may be used in the system of FIG. 5 in accordance with some embodiments.

### DETAILED DESCRIPTION

Controlling power consumption in microprocessors and other integrated circuit devices has increased in importance, especially with the greater use of mobile devices. Some existing techniques for managing processor power consumption have not adequately provided a dynamic scheme for setting various power management parameters relied upon by an integrated circuit device, such as a processor. The lack of a dynamic setting scheme for various power management parameters not only lessens the actual power savings realized, but also restricts the ability of users such as original equipment manufacturers (OEMs) to design products that can be overclocked, at least temporarily operating outside specifications established for the processor. At the same time, as integrated circuits move to newer process nodes with smaller features, transistor operation is being pushed to the edge of safe voltage and temperature regimes where the potential for thermal runaway is greatly increased. Increased power densities can lead to thermal runaway, causing functional failures and even permanent silicon damage. Accordingly, new ways to facilitate flexible programable voltage limits such as for overclocking would be desired.

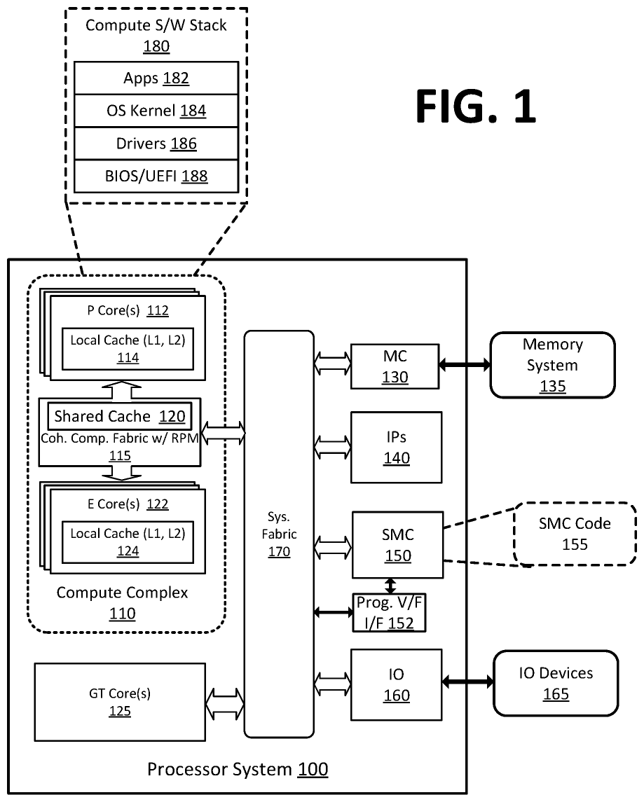

FIG. 1 is a block diagram of a processor system 100 in accordance with some embodiments. The processor system (or simply processor) 100 generally includes a compute complex 110, graphics technology (GT) core(s) 125, memory controller 130 with associated system memory 135, IP blocks 140, system management controller (SMC) 150 with associated V/F interface 152, and IO controller(s) 160 with associated IO devices 175, all coupled together as shown through system interconnect fabric 170. The system fabric 170 may be implemented with one or more busses, rings, point-to-point connections, and/or mesh networks, depending upon particular design configurations and objectives. (Note that IP stands for intellectual property and is typically used to indicate a re-usable block of functional circuitry for performing one or more functions. As used herein, the terms IP, IP block, or functional block may be used interchangeably, not only to refer to re-useable functional circuit blocks, whether self-designed or acquired from a third-party, but also, to product specific circuit blocks. Examples of functional, or IP, blocks include but are not limited to display engines, video processing units, image processing units, digital signal processing units, universal serial bus controllers, memory controllers, crypto encoders/decoders, processing cores, and the like.)

The compute complex 110 generally includes different compute (sometimes referred to as CPU cores) including P (performance) cores 112 and E (efficiency) cores 122 coupled together through coherent compute fabric 115. In the depicted embodiment, both the P and E cores include L1 and L2 cache, 114, 124, respectively, although the P core caches may be larger and/or configured differently to accommodate the particular demands of the P cores. For example, in some embodiments, the E cores 122 may be clustered together and share none, part or all of their L2 cache with each other, e.g., through a separate E cache fabric (not shown).

Both the P and E compute cores 112, 122 process software from software stack 180, which includes applications 182, operating system (OS) kernel modules 184, drivers 186, and BIOS (Basic Input/Output System)/UEFI (Unified Extensible Firmware Interface) boot code 188. The drivers allow the apps 182 and OS components 184 to monitor and/or control the hardware, or circuitry, within processor system 100. Among other things, the OS 184 and drivers 186 may work together with the SMC 150 to manage power and performance (PnP) for the various blocks within processor system 100.

The BIOS/UEFI 188 is used by the processor system for booting and also for configuring settings for the various circuit blocks. Most modern computing systems use a UEFI for these purposes, although some still use a traditional BIOS. Regardless, it is still common to refer to either as BIOS and thus, for simplicity, the term “BIOS” will be broadly used in this description, but it should be appreciated that as used herein, the term BIOS also refers to UEFI or equivalent boot software/firmware. Among other things, the BIOS may be used to program over-clocking parameters such as maximum voltage limits, discussed further below.

The P and E cores are different from each other with regard to their design bias toward performance or efficiency. In the depicted embodiment, for simplicity, two compute core types, P and E, are shown. P cores are generally designed with a bias toward higher performance capability at the expense of higher power consumption, while E cores are biased toward more efficient operation, consuming less power but with less performance potential. It should be appreciated that even though only two compute core types have been shown, there may be additional compute core types, or classes, within the compute complex 110, having different degrees or kinds of performance and processing efficiency capabilities. For example, higher performance capabilities may derive from having more robust instruction sets, e.g., from having additional instruction types such as floating point or advanced vector instructions and/or from having larger execution unit arrays such as with multiple instances of equivalent instructions.

The different performance capabilities of a core may be due to a core's architecture and size, but it also may be due to the way that the core is connected to the rest of the processor. For example, there may be uniform cores, but some may be on a separate power island that makes them more energy efficient. Also, identical cores on a remote chiplet may be the same type as those on a closer die but due to the relative differences in distance, may be lower in performance and less efficient.

In some embodiments, having different P and E core types may be referred to as a hybrid processing system implementation. Note that in many implementations, the different P/E type compute cores, while having different power/performance profiles, will typically have a common set architecture (ISA). In other embodiments, one or some of the different P/E core types may utilize different ISAs relative to the other P/E compute core types.

The SMC (system management controller) 150 includes one or more microcontrollers, state machines and/or other logic circuits for controlling various aspects of the processor system 100. For example, it may manage functions such as security, boot configuration, and power and performance including utilized and allocated power along with thermal management. The SMC may also be referred to as a P-unit, a power management unit (PMU), a power control unit (PCU), a system management unit (SMU) and the like and may include multiple SMCs, PMUs, die management controllers, etc., distributed, e.g., hierarchically, across multiple dies and/or die packages within the processor system 100. The SMC executes SMC code 155, which may include multiple separate software and/or firmware modules (sometimes referred to as P-code, Q-code, and/or A-code) to perform these and other functions. In some embodiments, it may perform routines, discussed further below, to determine, or assist in determining, configurable maximum voltage limits for voltage/frequency (V/F) operating points including for turbo and/or over-clocking scenarios.

(Note that it should be appreciated that the processor system 100 may be implemented in various different manners. For example, it may be implemented on a single die, multiple dies (dielets, chiplets), one or more dies in a common package, or one or more dies in multiple packages. Along these lines, some of the depicted blocks may be located separately on different dies or together on two or more different dies. In addition, while the terms “P/E” are used to delineate between higher and lower compute cores based on their processing performance and efficiency capabilities, it should be appreciated that other terms may be used such as “big/little,” “gold/silver”, and the like.)

Because dynamic power is a function of the square of a circuit's supplied voltage, voltage, in and of itself, can result in large heat generation in a small area, and lead to thermal runaway when pushing the voltage to enable faster clock speeds. Thermal runaway may initially cause functional failure but can eventually cause permanent damage to processor circuitry. This issue is more pronounced in overclocking scenarios as users are forcing the processor to run above factory configured voltage and frequency levels. At the same time, users and OEMs (original equipment manufacturers) who make computing systems out of processor systems, desire the freedom to be able to allow users to upwardly adjust operating voltage limits in order to overclock their systems. To arrive at a balance between providing predictably reliable processor systems and also providing flexibility to users to run their processors at higher voltage limits, in some embodiments, schemes to provide informed, configurable voltage limits may be provided.

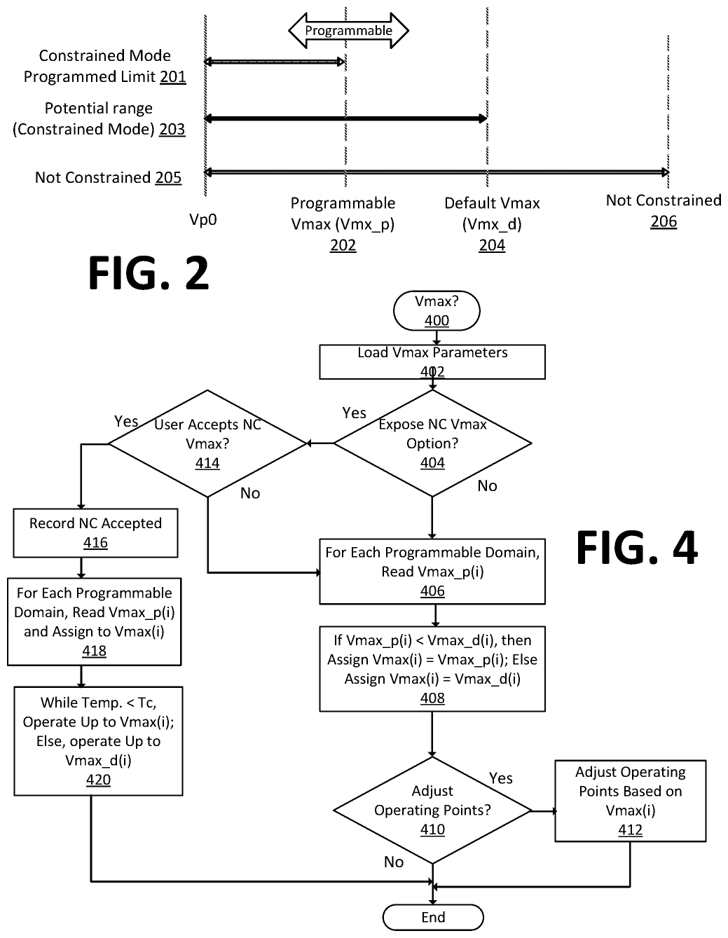

FIG. 2 is a diagram illustrating a framework for providing configurable processor maximum voltage limits in accordance with some embodiments. There are three supply voltage points along the X-axis: Vp0, a programmable Vmax set point (Vmax_p) 202, a default Vmax set point (Vmax_d) 204, and an unlimited (Not Constrained) Vmax set point 206. (Note that the voltage points along the X-axis may correspond to actual voltage levels or to offsets to be added to the Vp0 voltage or to another reference voltage.)

The Vp0 point corresponds to a voltage level (Vp)) determined, e.g., during manufacturing/testing, to be sufficient for running a frequency at a maximum default processor operating point. For example, with an ACPI (Advanced Configuration and Power Interface) voltage/frequency implementation, it may correspond to a voltage for facilitating a maximum P0 operating frequency without over-clocking the relevant circuit (e.g., compute core, graphics core, etc.).

The default Vmax(Vmax_d) 204 is a maximum voltage level to be applied to a given domain as characterized by a manufacturer. This range, relative to the Vp0 level, is illustrated at 203 as a potential, constrained mode maximum voltage limit. This may be a factory verified maximum voltage limit.

The programmable Vmax_p value (201) is a constrained, programmable maximum voltage level for limiting over-clocking voltages. An interface such as with a mailbox interface may be provided to allow an end-user or OEM to set this maximum voltage limit (Vmax_p). This limit is then enforced as the maximum voltage allowed. This limit can be applied to some or all overclockable IPs/domains, or a unique limit per IP/domain can be set. This capability allows for users such as OEMs to ensure their systems operate within targeted system design envelopes, preventing unintentional operation of processors outside of the system design limits.

In some embodiments, unless activating a not-constrained mode (discussed below), a user such as an OEM or end-user may be precluded from setting the programmable Vmax_p higher than the factory calibrated limit (Vmax_d). This maximum default value (Vmax_d) is typically hard-wired into a processor. For example, it may be fused into one or more integrated circuit (IC) chips of a processor system. This factory determined default limit protects casual overclocking users from unintentionally setting high voltage values in excess of safe operating levels. It can be the same for some or all overclockable domains within a processor system or can be separately defined for different domains.

In some embodiments, to enable greater freedom to OEMs and end users, an ability to elect a not constrained alternative may be provided. This is represented with the illustrated “Not Constrained” range 205, which allows a user to operate at unlimited supply voltage levels at their own risk.

To facilitate this capability, an “opt-in” option may be provided for a user to operate above the factory configured limit (Vmax_d). In some embodiments, this may be tracked by a sticky setting such as an infield programmable fuse being flipped in a processor package, or it could be delivered to customers with this configuration. This allows for manufacturers to be able to provide the not constrained capability and at the same time, be able to protect itself from defective product or invalid warranty claims.

In some embodiments, an additional feature to protect a processor from almost certain destruction, especially when the not constrained mode is enabled, is provided. It has been observed that even with advanced process node transistors that otherwise are highly fragile when exposed to excessive voltage drops (e.g., above 1.1 V or higher) can go well beyond these limits when the circuitry is sufficiently cold (e.g., below a critical temperature, Tc, such as −10 degrees C.). Accordingly, the alternative not constrained option may be provided where the unlimited, not constrained Vmax is activated but with a requirement that the circuit temperature is at or below a critical temperature level (Tc). Even with a very low Tc (e.g., −10 degrees C. or colder), this may still be useful since many overclocking enthusiasts are willing to employ extreme active cooling systems such as with liquid nitrogen and the like. When the user unlocks voltage limit enforcement, the processor allows cores (or other IPs) to run at higher voltages if the temperature is below the safe threshold (Tc). If the temperature rises above the safe temperature threshold value, the processor will reduce core/IP voltage and/or frequency. The safe temperature threshold can be enforced using any suitable manner such as equivalent on-chip sensor readouts or at external thermal control, accounting for the (potentially) larger spatial and temporal variations in temperature response at elevated voltages. Note that instead of, or in addition to, using a critical temperature trip point, a temperature curve may be used to correspondingly adjust the voltage limit in accordance with the temperature so that circuitry is sufficiently cold for a given extreme upper voltage limit. Also, while this temperature based voltage limit governor is described in connection with a not constrained mode, it should be appreciated that it could also be used with a constrained, programmable or default upper voltage limitation implementation.

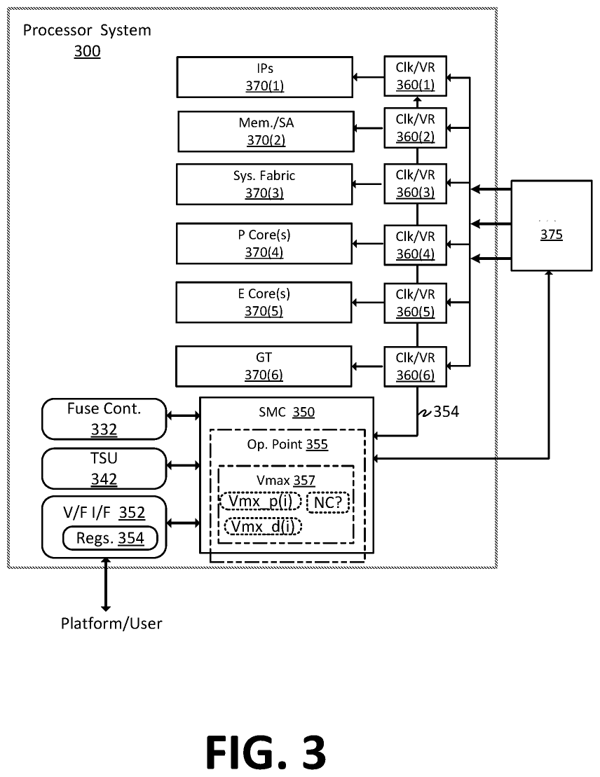

FIG. 3 is a block diagram showing a processor system 300 having configurable maximum voltage limits in accordance with some embodiments. As with the IC of FIG. 1, processor system 300 may be part of a single die or implemented with several dies, e.g., in a multi-chip system or module.

In some embodiments, manufacturers may allow different functional circuits to run above (or below) factory configured frequency and voltage limits. Examples of such blocks include, but are not limited to memory (memory controller/PHY layer), image processing unit, media, graphics, and fabrics (coherent/non-coherent). In this vein, processor system 300 includes several different clocking/VR (also referred herein as V/F) domain circuit blocks 360 including IP block(s) 370(1), memory/system agent block 370(2), system fabric 370(3), P-type compute cores 370(4), E-type compute core(s) 370(5), and a graphics technology block 370(6).

Each of these blocks is powered and clocked from an associated clock and voltage regulator (VR) circuit 360 (360(1) through 360(6)), which are powered from at least one off-chip power control unit (PCU) 375 that may include several different voltage regulators (e.g., buck type regulators) to provide regulated voltage supplies to the VRs within the V/F domain circuit blocks 370. The VRs within the Clk/VR circuits 360 may be implemented with any suitable voltage regulator circuits such as buck type, digital linear, low drop-out (LDO), and/or any other voltage regulator circuitry to provide reliable voltage supplies that can meet maximum voltage limits as provided for a user. Similarly, the clock generation circuits within the Clk/VR blocks may comprise phase-locked loop, delay locked loop, clock-tree, clock divider/multiplier and/or any other suitable circuits for providing clocks with sufficient frequencies to their associated circuit loads.

The processor system also includes a system management controller 350 coupled to the PCU 375 and Clk/VR circuits 360 to control voltage and frequency operating points for the V/F domain circuit blocks 370, e.g., in accordance with associated V/F curves, based on maximum voltage limits as discussed with regard to FIG. 2. Also included in the processor system is a fuse controller circuit 332, temperature sensing unit 342, and a voltage/frequency (V/F) interface (I/F) 352 coupled to the SMC 350.

The fuse controller circuit 332 reads fused parameters that may be programmed into the system. These parameters, among other things, may include measured voltage limits, as well as required voltage levels for associated frequencies for the various V/F domains. The programmed data may be stored using traditional fuse circuits or with any other suitable storage circuit structures.

The thermal sense unit (TSU) 342 includes one or more temperature sensor circuits, as well as logic and memory circuits to measure operating temperatures within the processor system. The temperature sense circuits generate digital output signals indicative of their sensed temperatures. Sense elements for the temperature sense circuits are disposed within the system, as part of the silicon circuitry and/or processor system package, and at least some likely will be located sufficiently near the V/F domain circuits to provide meaningful temperature information. The temperature sensor circuits may be implemented with any suitable temperature sense solutions. For example, configurations using resistors, thermistors, diodes and/or transistors or combinations of the same could be employed. An integrated circuit approach is to use transistor/diode configurations that employ band gap reference techniques. The digital temperature signals from temperature sensor circuits are provided to the SMC 350, which may use one, some or all of these temperature values. It may generate an aggregate value, a highest value, an average value, or a combination of one or more of the values, e.g., depending on where the sensors are located and what functional blocks are being operated. In some embodiments, the TSU 342 may be programmable to set thresholds or threshold ranges that may serve to determine when a temperature signal is transmitted to the SMC, e.g., as an asynchronous interrupt or memory register update.

The V/F interface 352 facilitates communications to the SMC from outside of the processor system, e.g., through a BIOS mailbox interface having one or more registers such as so-called model specific registers (MSRs). Other interface schemes may be used such as memory management input/output (MMIO) writes. Through the V/F interface 352, users such as end users or OEMs may enable over-clocking, not constrained modes, set maximum voltage (Vmax) limits, e.g., for one or more V/F domain circuit blocks, and/or edit V/F operating point curves for some or all of the domain circuit blocks.

The SMC 350 has an operating point module 355 to control the V/F operating points for some or all of the various domain circuit blocks 370. The module may be implemented with logic such as circuits and/or code such as firmware and may include components that are part of a common V/F management engine or separate power management modules for the various domain blocks. To do this, it may have access to the programmed parameters including default max. domain voltage limits (Vmax_d(i)), programmed max. domain voltage limits (Vmax_p(i)), and a constrained or not constrained flag (NC?). It may also have other parameters related to overclocking and for providing different levels of access depending on the user. The operating point module may use this information in setting the various V/F control points for the domain blocks 370 through the Clk/VR circuits 360. It may also apply user adjusted V/F curves, either defined directly by a user or through, for example, SMC supported interpolation of predefined curves based on parameters provided by a user.

FIG. 4 is a flow diagram of a routine 400 to identify a maximum voltage limit in accordance with some embodiments. At 402, the routine loads Vmax parameters such as Vmax_p and Vmax_d and whether and how an overclocking feature may be implemented. At 404, it determines if a NC (not constrained) option may be made available to a user. If not, it proceeds to 406.

At 406, the routine reads Vmax_p(i) for each V/F domain block. At 408, if for each domain, if Vmax_p(i) is less than Vmax_d(i), then it assigns Vmax_p(i) to the Vmax(i) limit, the limit to be used by the operating point module. Otherwise, if a Vmax_p(i) value is greater or equal to its corresponding Vmax_d(i) value, then it assigns to the Vmax(i) limit the Vmax_d(i) value.

At 410 the routine determines, for each domain operating point curve whether or not its overall curve is to be adjusted. If so, then at 412, it adjusts the operating point curve based on the Vmax(i) value, as well possibly, on specific operating points, frequencies, or voltages entered by a user, although the Vmax(i) value may be used as an upper limit. At 410, if an operating point is not to be adjusted, then the routine ends, using the Vmax(i) value(s) as an upper voltage limit for an existing V/F or other overclocking curve.

Returning back to 404, if an NC option is made available, then the routine proceeds to 414 and determines if the NC (not constrained Vmax) is accepted by a user. If not, then it proceeds to 406 and performs as described above. Otherwise, if an NC option is accepted, then it proceeds to 416 and records the NC acceptance. For example, it may blow a fuse or set a bit to convey the acceptance to a manufacturer or third-party agent. In some embodiments, this is a sticky bit, e.g., may only be set by a BIOS, and not clearable by a mailbox command apart from a BIOS interface command. In some embodiments, this setting may persist over warm resets and clear on cold resets.

At 418, the routine reads Vmax_p(i) for each programmable domain and assigns the value to Vmax(i). If no value has been programmed for a domain, then it may use a default limit. From here, it proceeds to 420 and operates with the unlimited Vmax(i) value unless the domain's circuit temperature goes above the critical temperature (Tc). If so, then it uses a default limit, or it even may throttle the V/F level down depending on monitored temperature value(s) or other real-time conditions. The routine continues in this mode until a reset event or restart event, e.g., BIOS reloaded, whereupon it may begin once again at 402.

It should be appreciated that while techniques discussed herein have primarily been addressed toward overclocking voltage limits, they may be employed for other electrical limits such as current and for operational modes other than overclocking.

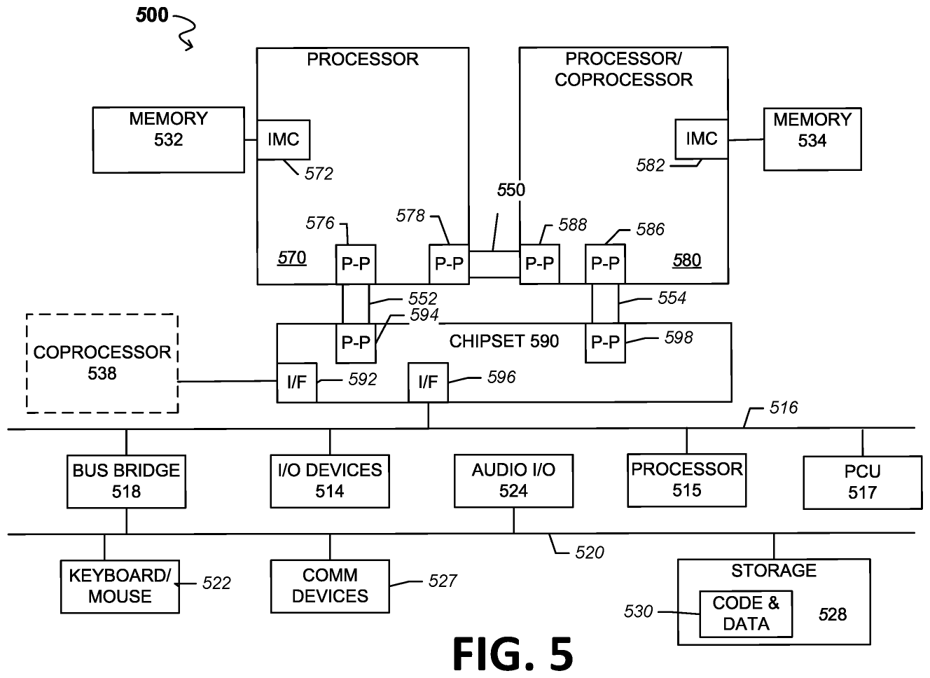

FIG. 5 illustrates an example computing system. Multiprocessor system 500 is an interfaced system and includes a plurality of processors including a first processor 570 and a second processor 580 coupled via an interface 550 such as a point-to-point (P-P) interconnect, a fabric, and/or bus. In some examples, the first processor 570 and the second processor 580 are homogeneous. In some examples, first processor 570 and the second processor 580 are heterogenous. Though the example system 500 is shown to have two processors, the system may have three or more processors, or may be a single processor system. In some examples, the computing system is implemented, wholly or partially, with a system on a chip (SoC) or a multi-chip (or multi-chiplet) module, in the same or in different package combinations.

Processors 570 and 580 are shown including integrated memory controller (IMC) circuitry 572 and 582, respectively. Processor 570 also includes interface circuits 576 and 578, along with core sets. Similarly, second processor 580 includes interface circuits 586 and 588, along with a core set as well. A core set generally refers to one or more compute cores that may or may not be grouped into different clusters, hierarchal groups, or groups of common core types. Cores may be configured differently for performing different functions and/or instructions at different performance and/or power levels. The processors may also include other blocks such as memory and other processing unit engines.

Processors 570, 580 may exchange information via the interface 550 using interface circuits 578, 588. IMCs 572 and 582 couple the processors 570, 580 to respective memories, namely a memory 532 and a memory 534, which may be portions of main memory locally attached to the respective processors.

Processors 570, 580 may each exchange information with a network interface (NW I/F) 590 via individual interfaces 552, 554 using interface circuits 576, 594, 586, 598. The network interface 590 (e.g., one or more of an interconnect, bus, and/or fabric, and in some examples is a chipset) may optionally exchange information with a coprocessor 538 via an interface circuit 592. In some examples, the coprocessor 538 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 570, 580 or outside of both processors, yet connected with the processors via an interface such as P-P interconnect, such that either or both processors' local cache information may be stored in the shared cache if a processor is placed into a low power mode.

Network interface 590 may be coupled to a first interface 516 via interface circuit 596. In some examples, first interface 516 may be an interface such as a Peripheral Component Interconnect (PCI) interconnect, a PCI Express interconnect, or another I/O interconnect. In some examples, first interface 516 is coupled to a power control unit (PCU) 517, which may include circuitry, software, and/or firmware to perform power management operations with regard to the processors 570, 580 and/or co-processor 538. PCU 517 provides control information to one or more voltage regulators (not shown) to cause the voltage regulator(s) to generate the appropriate regulated voltage(s). PCU 517 also provides control information to control the operating voltage generated. In various examples, PCU 517 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software) in accordance with programmable V/F voltage limits as described herein. The PCU 517 may function as an SMC from FIG. 1 or 3.

PCU 517 is illustrated as being present as logic separate from the processor 570 and/or processor 580. In other cases, PCU 517 may execute on a given one or more of cores (not shown) of processor 570 or 580. In some cases, PCU 517 may be implemented as a microcontroller (dedicated or general-purpose) or other control logic configured to execute its own dedicated power management code, sometimes referred to as P-code. In yet other examples, power management operations to be performed by PCU 517 may be implemented externally to a processor, such as by way of a separate power management integrated circuit (PMIC) or another component external to the processor. In yet other examples, power management operations to be performed by PCU 517 may be implemented within BIOS or other system software. Along these lines, power management may be performed in concert with other power control units implemented autonomously or semi-autonomously, e.g., as controllers or executing software in cores, clusters, IP blocks and/or in other parts of the overall system.

Various I/O devices 514 may be coupled to first interface 516, along with a bus bridge 518 which couples first interface 516 to a second interface 520. In some examples, one or more additional processor(s) 515, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 516. In some examples, second interface 520 may be a low pin count (LPC) interface. Various devices may be coupled to second interface 520 including, for example, a keyboard and/or mouse 522, communication devices 527 and storage circuitry 528. Storage circuitry 528 may be one or more non-transitory machine-readable storage media as described below, such as a disk drive or other mass storage device which may include instructions/code and data 530 and may implement the storage in some examples. Further, an audio I/O 524 may be coupled to second interface 520. Note that other architectures than the point-to-point architecture described above are possible. For example, instead of the point-to-point architecture, a system such as multiprocessor system 500 may implement a multi-drop interface or other such architecture.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

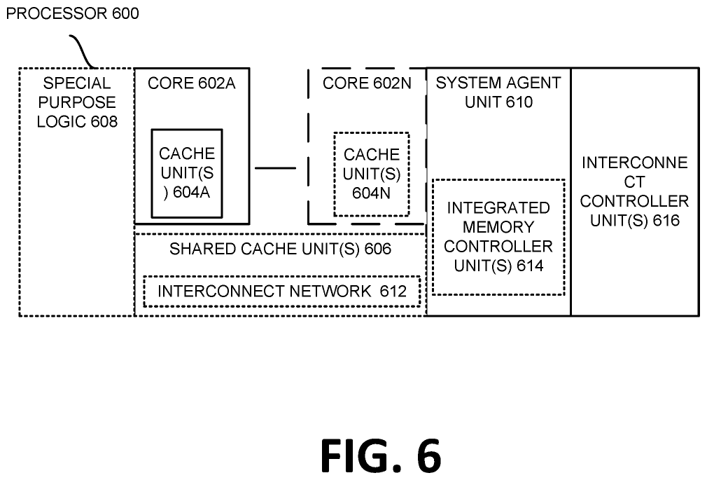

FIG. 6 illustrates a block diagram of an example processor 600 that may be used in the system of FIG. 5 in accordance with some embodiments. The depicted processor may have one or more cores and an integrated memory controller. The solid lined boxes illustrate a processor 600 with a single core 602(A), system agent unit circuitry 610, and a set of one or more interface controller unit(s) circuitry 616, while the optional addition of the dashed lined boxes illustrates an alternative processor 600 with multiple cores 602(A)-(N), a set of one or more integrated memory controller unit(s) circuitry 614 in the system agent unit circuitry 610, and special purpose logic 608, as well as a set of one or more interface controller units circuitry 616. Note that the processor 600 may be one of the processors 570 or 580, or co-processor 538 or 515 of FIG. 5.

Thus, different implementations of the processor 600 may include: 1) a CPU with the special purpose logic 608 being integrated graphics and/or scientific (throughput) logic (which may include one or more cores, not shown), and the cores 602(A)-(N) being one or more general purpose cores (e.g., general purpose in-order cores, general purpose out-of-order cores, or a combination of the two); 2) a coprocessor with the cores 602(A)-(N) being a large number of special purpose cores intended primarily for graphics and/or scientific (throughput); and 3) a coprocessor with the cores 602(A)-(N) being a large number of general purpose in-order cores. Thus, the processor 600 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 600 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 604(A)-(N) within the cores 602(A)-(N), a set of one or more shared cache unit(s) circuitry 606, and external memory (not shown) coupled to the set of integrated memory controller unit(s) circuitry 614. The set of one or more shared cache unit(s) circuitry 606 may include one or more mid-level caches, such as level 2 (L2), level 3 (L3), level 4 (L4), or other levels of cache, such as a last level cache (LLC), and/or combinations thereof. While in some examples interface network circuitry 612 (e.g., a ring interconnect) interfaces the special purpose logic 608 (e.g., integrated graphics logic), the set of shared cache unit(s) circuitry 606, and the system agent unit circuitry 610, alternative examples use any number of well-known techniques for interfacing such units. In some examples, coherency is maintained between one or more of the shared cache unit(s) circuitry 606 and cores 602(A)-(N). In some examples, interface controller units circuitry 616 couple the cores 602 to one or more other devices 618 such as one or more I/O devices, storage, one or more communication devices (e.g., wireless networking, wired networking, etc.), etc.

In some examples, one or more of the cores 602(A)-(N) are capable of multi-threading. The system agent unit circuitry 610 includes those components coordinating and operating cores 602(A)-(N). The system agent unit circuitry 610 may include, for example, power control unit (PCU) circuitry and/or display unit circuitry (not shown). The PCU may be or may include logic and components needed for regulating the power state of the cores 602(A)-(N) and/or the special purpose logic 608 (e.g., integrated graphics logic). The display unit circuitry is for driving one or more externally connected displays.

The cores 602(A)-(N) may be homogenous in terms of instruction set architecture (ISA). Alternatively, the cores 602(A)-(N) may be heterogeneous in terms of ISA; that is, a subset of the cores 602(A)-(N) may be capable of executing an ISA, while other cores may be capable of executing only a subset of that ISA or another ISA.

Illustrative examples of the technologies disclosed herein are provided below. An embodiment of the technologies may include any one or more, and any compatible combination of, the examples described below.
Example 1 is an apparatus that includes a V/F domain circuit, a voltage regulator, an interface circuit, and a controller circuit. The voltage/frequency (V/F) domain circuit has a V/F supply voltage input. The voltage regulator is coupled to the V/F supply voltage input to provide it with a V/F supply voltage. The interface circuit is to receive a programmable V/F voltage limit for the V/F supply voltage. The controller circuit is coupled to the voltage regulator to control the V/F supply voltage with an upper limit corresponding to the programmable V/F voltage limit if it is less than or equal to a default V/F voltage limit.
Example 2 includes the subject matter of example 1, and wherein the controller circuit is to control the V/F supply voltage with the upper limit corresponding to the default V/F voltage limit if the programmable V/F voltage limit is greater than the default V/F voltage limit.
Example 3 includes the subject matter of any of examples 1-2, and wherein the controller circuit is at least part of a system management controller circuit.
Example 4 includes the subject matter of any of examples 1-3, and comprising a fuse circuit coupled to the controller circuit to provide the default V/F voltage limit.
Example 5 includes the subject matter of any of examples 1-4, and comprising multiple V/F domain circuits that include the V/F domain circuit, the multiple V/F domain circuits including at least one compute core circuit and at least one memory circuit having upper limit V/F supply voltages corresponding to programmable V/F voltage limits.
Example 6 includes the subject matter of any of examples 1-5, and wherein the interface circuit comprises one or more programmable register circuits.
Example 7 includes the subject matter of any of examples 1-6, and wherein the one or more programmable register circuits include registers that are programmable by a BIOS and accessible to the controller circuit.
Example 8 includes the subject matter of any of examples 1-7, and wherein the one or more programmable register circuits include at least one register for storing overclocking parameters.
Example 9 includes the subject matter of any of examples 1-8, and wherein the one or more programmable register circuits include mailbox registers.
Example 10 includes the subject matter of any of examples 1-9, and comprising a temperature sense circuit coupled to the controller circuit to provide a measured temperature, the controller circuit to allow the programmable V/F voltage to go above the default V/F voltage if the measured temperature is less than a critical temperature.
Example 11 includes the subject matter of any of examples 1-10, and wherein the controller circuit is to allow the programmable V/F voltage to go above the default V/F voltage if a not constrained value is set.
Example 12 is a multi-die processor system having an apparatus in accordance with the subject matter of any of examples 1-11.
Example 13 is a computer readable storage medium having instructions. When executed, the instructions perform a method that includes receiving a programmable V/F voltage limit from a user, and controlling an associated V/F supply voltage using an upper limit corresponding to the received programmable V/F voltage limit if it is less than or equal to a default V/F voltage limit.
Example 14 includes the subject matter of example 13, and wherein the method comprises controlling the V/F supply voltage with the upper limit corresponding to the default V/F voltage limit if the programmable V/F voltage limit is greater than the default V/F voltage limit.
Example 15 includes the subject matter of any of examples 13-14, and wherein the act of receiving a programmable V/F voltage limit from a user includes receiving the programmable V/F limit if an overclocking mode is enabled and controlling the associated V/F supply voltage using a non-overclocking mode V/F upper limit.
Example 16 includes the subject matter of any of examples 13-15, and wherein the method comprises using the programmable V/F voltage as the upper limit even if greater than the default V/F voltage if a not constrained option is enabled.
Example 17 includes the subject matter of any of examples 13-16, and wherein the method comprises logging the enabled not constrained option being enabled.
Example 18 is a processor system having a controller circuit coupled to a memory in accordance with the subject matter of any of examples 13-17.
Example 19 includes the subject matter of example 18, and comprising a programmably overclockable compute core domain and a programmably overclockable IP domain.
Example 20 is a processor system that includes a first IC die, a first voltage regulator, an interface circuit, and a controller circuit. The first integrated circuit (IC) die has a compute core circuit with a first V/F supply voltage input. The first voltage regulator is coupled to the first V/F supply voltage input to provide it with a first V/F supply voltage. The interface circuit is to receive a programmable first V/F voltage limit for the first V/F supply voltage. The controller circuit is coupled to the first voltage regulator to control the first V/F supply voltage with an upper limit corresponding to the programmable first V/F voltage limit if an overclocking mode is enabled.
Example 21 includes the subject matter of example 20, and wherein the upper limit corresponds to the programmable first V/F voltage limit if it is less than or equal to a default first V/F voltage limit.
Example 22 includes the subject matter of any of examples 20-21, and wherein the controller circuit is to control the first V/F supply voltage with the upper limit corresponding to the default first V/F voltage limit if the programmable first V/F voltage limit is greater than the default first V/F voltage limit.
Example 23 includes the subject matter of any of examples 20-22, and wherein the controller circuit is at least part of a system management controller circuit.
Example 24 includes the subject matter of any of examples 20-23, and comprising a fuse circuit coupled to the controller circuit to provide the default first V/F voltage limit.
Example 25 includes the subject matter of any of examples 20-24, and comprising a second IC die having a graphics core circuit with a second V/F supply voltage input to receive a second V/F supply voltage from a second VR.
Example 26 includes the subject matter of any of examples 20-25, and wherein the interface circuit is to receive a programmable second V/F voltage limit for the second V/F supply voltage, and the controller circuit is to control the second V/F supply voltage with a second upper limit corresponding to the programmable second V/F voltage limit.
Example 27 includes the subject matter of any of examples 20-26, and wherein the interface circuit comprises one or more programmable register circuits.
Example 28 includes the subject matter of any of examples 20-27, and wherein the one or more programmable register circuits include registers that are programmable by a BIOS and accessible to the controller circuit.
Example 29 includes the subject matter of any of examples 20-28, and wherein the one or more programmable register circuits include at least one register for storing overclocking parameters.
Example 30 includes the subject matter of any of examples 20-29, and wherein the one or more programmable register circuits include mailbox registers.
Example 31 includes the subject matter of any of examples 20-30, and comprising a temperature sense circuit coupled to the controller circuit to provide a measured temperature, the controller circuit to allow the programmable first V/F voltage to go above the default first V/F voltage if the measured temperature is less than a critical temperature.
Example 32 includes the subject matter of any of examples 20-31, and wherein the controller circuit is to allow the programmable first V/F voltage to go above the default first V/F voltage if a not constrained value is set.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included.

Throughout the specification, and in the claims, the term “connected” means a direct connection, such as electrical, mechanical, or magnetic connection between the things that are connected, without any intermediary devices.

The term “coupled” means a direct or indirect connection, such as a direct electrical, mechanical, or magnetic connection between the things that are connected or an indirect connection, through one or more passive or active intermediary devices.

The term “circuit” or “module” may refer to one or more passive and/or active components that are arranged to cooperate with one another to provide a desired function. It should be appreciated that different circuits or modules may consist of separate components, they may include both distinct and shared components, or they may consist of the same components. For example, A controller circuit may be a first circuit for performing a first function, and at the same time, it may be a second controller circuit for performing a second function, related or not related to the first function.

The meaning of “in” includes “in” and “on” unless expressly distinguished for a specific description.

The terms “substantially,” “close,” “approximately,” “near,” and “about,” unless otherwise indicated, generally refer to being within +/−10% of a target value.

Unless otherwise specified, the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

For the purposes of the present disclosure, phrases “A and/or B” and “A or B” mean (A), (B), or (A and B). For the purposes of the present disclosure, the phrase “A, B, and/or C” means (A), (B), (C), (A and B), (A and C), (B and C), or (A, B and C).

It is pointed out that those elements of the figures having the same reference numbers (or names) as the elements of any other figure can operate or function in any manner similar to that described but are not limited to such.

For purposes of the embodiments, unless expressly described differently, the transistors in various circuits and logic blocks described herein may be implemented with any suitable transistor type such as field effect transistors (FETs) or bipolar type transistors. FET transistor types may include but are not limited to metal oxide semiconductor (MOS) type FETs such as tri-gate, FinFET, and gate all around (GAA) FET transistors, as well as tunneling FET (TFET) transistors, ferroelectric FET (FeFET) transistors, or other transistor device types such as carbon nanotubes or spintronic devices.

In addition, well-known power/ground connections to integrated circuit (IC) chips and other components may or may not be shown within the presented figures, for simplicity of illustration and discussion, and so as not to obscure the disclosure. Further, arrangements may be shown in block diagram form in order to avoid obscuring the disclosure, and also in view of the fact that specifics with respect to implementation of such block diagram arrangements are dependent upon the platform within which the present disclosure is to be implemented.

As defined herein, the term “computer readable storage medium” means a storage medium that contains or stores program code for use by or in connection with an instruction execution system, apparatus, or device. As defined herein, a “computer readable storage medium” is not a transitory, propagating signal per se. A computer readable storage medium may be, but is not limited to, an electronic storage device, a magnetic storage device, an optical storage device, an electromagnetic storage device, a semiconductor storage device, or any suitable combination of the foregoing. Memory elements, as described herein, are examples of a computer readable storage medium.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context. As defined herein, the term “responsive to” means responding or reacting readily to an action or event. Thus, if a second action is performed “responsive to” a first action, there is a causal relationship between an occurrence of the first action and an occurrence of the second action. The term “responsive to” indicates the causal relationship.

As defined herein, the term “processor” means at least one hardware circuit configured to carry out instructions contained in program code. The hardware circuit may be implemented with one or more integrated circuits. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, a graphics processing unit (GPU), a controller, and so forth. It should be appreciated that a logical processor, on the other hand, is a processing abstraction associated with a core, for example when one or more SMT cores are being used such that multiple logical processors may be associated with a given core, for example, in the context of core thread assignment.

It should be appreciated that a processor or processor system may be implemented in various different manners. For example, it may be implemented on a single die, multiple dies (dielets, chiplets), one or more dies in a common package, or one or more dies in multiple packages. Along these lines, some of these blocks may be located separately on different dies or together on two or more different dies.

While the flow diagrams in the figures show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. An apparatus, comprising:
a voltage/frequency (V/F) domain circuit having a V/F supply voltage input;
a voltage regulator coupled to the V/F supply voltage input to provide it with a V/F supply voltage;
an interface circuit to receive a programmable V/F voltage limit for the V/F supply voltage; and
a controller circuit coupled to the voltage regulator to control the V/F supply voltage with an upper limit corresponding to the programmable V/F voltage limit if it is less than or equal to a default V/F voltage limit.

2. The apparatus of claim 1, wherein the controller circuit is to control the V/F supply voltage with the upper limit corresponding to the default V/F voltage limit if the programmable V/F voltage limit is greater than the default V/F voltage limit.

3. The apparatus of claim 1, comprising a fuse circuit coupled to the controller circuit to provide the default V/F voltage limit.

4. The apparatus of claim 1, comprising multiple V/F domain circuits that include the V/F domain circuit, the multiple V/F domain circuits including at least one compute core circuit and at least one memory circuit having upper limit V/F supply voltages corresponding to programmable V/F voltage limits.

5. The apparatus of claim 1, wherein the interface circuit comprises one or more programmable register circuits.

6. The apparatus of claim 5, wherein the one or more programmable register circuits include registers that are programmable by a BIOS and accessible to the controller circuit.

7. The apparatus of claim 6, wherein the one or more programmable register circuits include at least one register for storing overclocking parameters.

8. The apparatus of claim 1, comprising a temperature sense circuit coupled to the controller circuit to provide a measured temperature, the controller circuit to allow the programmable V/F voltage to go above the default V/F voltage if the measured temperature is less than a critical temperature.

9. The apparatus of claim 8, wherein the controller circuit is to allow the programmable V/F voltage to go above the default V/F voltage if a not constrained value is set.

10. A computer readable storage medium having instructions that when executed within a processing system perform a method comprising:
receiving a programmable V/F voltage limit from a user; and
controlling an associated V/F supply voltage using an upper limit corresponding to the received programmable V/F voltage limit if it is less than or equal to a default V/F voltage limit.

11. The storage medium of claim 10, wherein the method comprises controlling the V/F supply voltage with the upper limit corresponding to the default V/F voltage limit if the programmable V/F voltage limit is greater than the default V/F voltage limit.

12. The storage medium of claim 10, wherein the act of receiving a programmable V/F voltage limit from a user includes receiving the programmable V/F limit if an overclocking mode is enabled and controlling the associated V/F supply voltage using a non-overclocking mode V/F upper limit.

13. The storage medium of claim 10, wherein the method comprises using the programmable V/F voltage as the upper limit even if greater than the default V/F voltage if a not constrained option is enabled.

14. The storage medium of claim 13, wherein the method comprises logging the enabled not constrained option being enabled.

15. A processor system having a controller circuit coupled to a memory in accordance with the storage medium of claim 10.

16. A processor system, comprising:
a first integrated circuit (IC) die having a compute core circuit with a first V/F supply voltage input;
a first voltage regulator coupled to the V/F supply voltage input to provide it with a first V/F supply voltage;
an interface circuit to receive a programmable first V/F voltage limit for the first V/F supply voltage; and
a controller circuit coupled to the first voltage regulator to control the first V/F supply voltage with an upper limit corresponding to the programmable first V/F voltage limit if an overclocking mode is enabled.

17. The system of claim 16, wherein the upper limit corresponds to the programmable first V/F voltage limit if it is less than or equal to a default first V/F voltage limit.

18. The system of claim 17, wherein the controller circuit is to control the first V/F supply voltage with the upper limit corresponding to the default first V/F voltage limit if the programmable first V/F voltage limit is greater than the default first V/F voltage limit.

19. The system of claim 16, wherein the controller circuit is at least part of a system management controller circuit.

20. The system of claim 16, comprising a second IC die having a graphics core circuit with a second V/F supply voltage input to receive a second V/F supply voltage from a second VR.
